(19) United States
(12) Patent Application Publication
(10) Pub. No.: US 2008/0156617 A1
(43) Pub. Date: Jul. 3, 2008

(54) Conveyor System

(76) Inventors: Hans-Peter Wild, Eppelheim (DE); Eberhard Kraft, Neckarbischofsheim (DE)

Correspondence Address: STROOCK & STROOCK & LAVAN LLP, 180 MAIDEN LANE, NEW YORK, NY, 10038, US

(21) Appl. No.: 11/940,931

(22) Filed: Nov. 15, 2007

(30) Foreign Application Priority Data
Nov. 15, 2006 (EP) 06023744.3

(51) Int. Cl. B65G 37/00; B65G 21/10

(52) U.S. Cl. 198/347.1; 198/861.1

(57) ABSTRACT

A conveying system is provided wherein a conveying member rotates about a plurality of rollers, wherein one roller is pivotally displaceable with respect to another roller. Preferably, the displaceable roller can be urged toward or away from the conveying member to adjust the tension of the conveying member.

### BACKGROUND OF THE INVENTION

This invention relates, in general, to a conveying system for conveying an article, wherein the conveying system includes a continuously rotating conveying member having a plurality of holding members for grasping and holding articles being conveyed.

A conveying system often includes a conveying member rotating around two deflection rollers. Depending on the desired progression, three or more deflection rollers can be provided. Continuously rotating conveying members, such as chains or belts, however, can lose their tension with continued use, for example, between the deflection rollers. For example, the conveying member can stretch out and become elongated, the deflection rollers can wear out, etc.

Reduced tension of the conveying member can result in a deviation of the conveying path. For example, the conveying member can inadvertently slip around the deflection rollers, or the articles being conveyed can become misaligned. One known remedy for the potential deviation is a belt tensioning device, wherein a deflection element is pressed against the conveying member. The deflection element is typically applied externally from the loop of the conveying path. Therefore, the increased length of the conveying member can be compensated by increasing the distance traveled by the conveying member. Thus the tension of the conveying member can be maintained constant. However, such tensioning devices can create deflections of the conveying member, which can require an increase in driving power.

In light of the shortcomings described above, it is desirable to provide an improved conveying system.

### SUMMARY

Generally speaking, the present invention is directed toward a conveying system having a conveying member, a plurality of holding members connected to the conveying member, and a tensioning device. The tensioning device preferably includes a fixed roller and a roller displaceable with respect to the fixed roller. Preferably, displacing the displaceable roller adjusts the tension of the conveying member. The tensioning device can also include a lever connecting the rollers, the lever preferably being pivotable about a pivot point. More preferably, the fixed roller rotates about the same pivot point.

Preferably, the conveying system includes one or more additional rollers, at least one of the additional rollers positioned apart from the lever. The tensioning device can also include a cam which the holding members can contact, wherein the holding members are adjusted, for example, to open and close to receive and retain an article respectively.

An object of the invention is to provide an improved conveyor system as described herein.

Other objects and features of the present invention will become apparent from the following detailed description, considered in conjunction with the accompanying drawing FIGURE. It is to be understood, however, that the drawing is designed solely for the purpose of illustration and not as a definition of the limits of the invention, for which reference should be made to the appended claims.

### BRIEF DESCRIPTION OF THE FIGURE

For a fuller understanding of the invention, reference is had to the following description, taken in connection with the accompanying drawing, in which:

FIG. 1 is a schematic diagram of a conveyor system in accordance with an embodiment of the invention.

### DETAILED DESCRIPTION

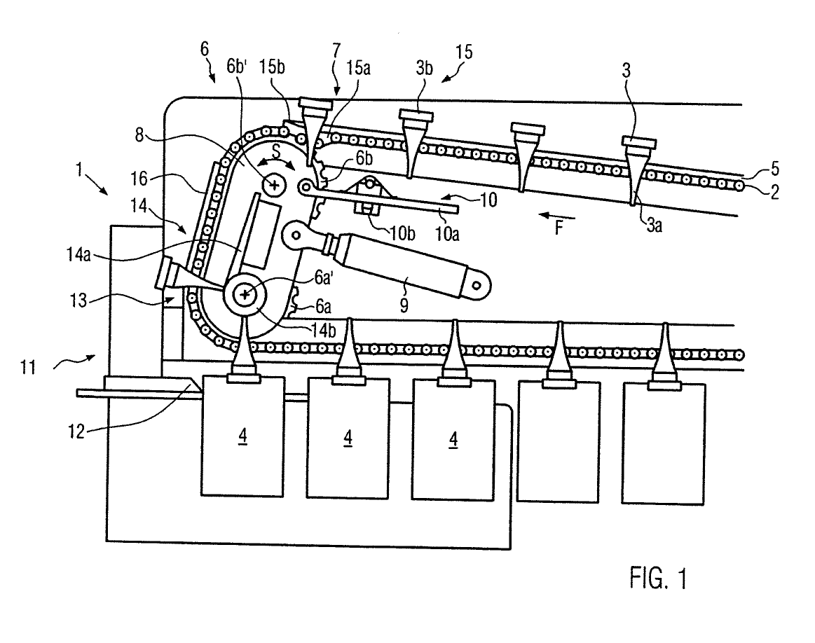

Reference is made to FIG. 1, wherein an embodiment of a conveyor system generally indicated at 1 is illustrated. As shown, a conveying member 2 is preferably a continuously rotating member, such as a chain or belt. A plurality of holding members 3 can be connected to conveying member 2, preferably at predetermined intervals with respect to one another. Each holding member 3 is preferably constructed and arranged to selectively grasp and release an article 4. The construction and arrangement of holding member 3 can be varied according to article 4, for example, the article's size, shape, weight, etc. For example, article 4 can be a bag, such as a foil bag for a beverage, which has a sealing seam proximate the top of the bag. Holding member 3 can grasp article 4 proximate the seam to pick up and transport article 4.

An exemplary embodiment of the conveyor system 1 includes a plurality of rollers 6, by way of non-limiting example, deflection rollers about which conveying member 2 can rotate. Referring to FIG. 1, conveying member 2 can move in a conveying direction F. Preferably a first roller 6a and a second roller 6b rotate about a first pivot 6a′ and second pivot 6b′, respectively. A third roller (not shown) can be provided, for example, apart from first and second rollers 6a, 6b, to create three or more points about which conveying member 2 rotates. It is to be understood that additional rollers are contemplated and do not deviate from the scope of the invention.

Preferably, a driving mechanism is provided to urge conveying member 2 in conveying direction F to rotate about rollers 6. By way of non-limiting example, one of rollers 6, for example, first roller 6a, can be a drive roller, while the other roller, for example, second roller 6b, can rotate freely as conveying member 2 rotates about rollers 6. Alternatively, one or more additional rollers (not shown) can be the drive roller. Additionally, more than one drive roller can be provided as a matter of application specific design choice without deviating from the scope of the invention.

In accordance with the embodiment shown in FIG. 1, first roller 6a is fixed and second roller 6b is displaceable with respect to first roller 6a. First roller 6a and second roller 6b can be connected to a pivotable lever 8 which is more preferably pivotable about first pivot 6a′. Second roller 6b can be positioned above first roller 6a such that pivot points 6a′, 6b′ are parallel to each other. Preferably, if a line were drawn between pivots 6a′ and 6b′ and a horizontal line were drawing extending through first pivot 6a′, the lines would form an acute angle, more preferably an angle of greater than about 45°.

Conveying system 1 can include a tensioning assembly 7 for adjusting the tension of conveying member 2. In the embodiment illustrated, tensioning assembly 7 includes second roller 6b mounted on a lever 8, preferably a tension lever constructed and arranged to pivot about first pivot 6a′. Thus second roller 6b can rotate about second pivot 6b′ and pivot about first pivot 6a′ together with lever 8. The pivoting motion of lever 8 and second roller 6b is indicated by double arrow S.

Rollers 6a, 6b preferably can be varied, for example, depending on the desired flexibility and need of the conveyor system 1. More preferably, rollers 6a, 6b are constructed and arranged to permit conveying member 2 to rotate about rollers 6a, 6b at a reduced risk of jamming at higher speeds than currently available in the market. In accordance with an embodiment of the conveyor system, conveying member 2 comprises a chain, and rollers 6a, 6b include chain wheels.

Referring to the embodiment shown in FIG. 1, as lever 8 and second roller 6b pivot about pivot 6a′, second roller 6b is displaced in direction S, thus altering the distance being traveled by conveying member 2. Therefore, as conveying member 2 becomes elongated, for example, as a belt loses elasticity, the path of conveying member 2 can be extended by displacing second roller 6b, preferably toward conveying member 2. The tension of conveying member 2 can thus be maintained constant by displacing second roller 6b.

The tensioning assembly 7 preferably also includes an adjustment member 9, such as an adjustment cylinder, connected to lever 8. Alternate adjustment members 9 can be provided, for example, to apply a force on lever 8, pivot 6b′ or second roller 6b. Other alternatives can be provided as a matter of application specific design choice.

Referring to FIG. 1, tensioning assembly 7 can further include a locking mechanism 10 constructed and arranged to maintain second roller 6b in the desired position. For example, once the desired tension of conveying member 2 is achieved by displacing second roller 6b, locking mechanism 10 can retain second roller 6b in place to maintain the desired tension. Examples of locking mechanism 10 include, but is not limited to, a locking lever 10a connected to lever 8 as well as a spring holding member 10b. Locking mechanism 10 can be continuously variable, for example, via friction, or include a plurality of step lock positions. By providing a locking mechanism, adjustment member 9 need not maintain second roller 6b, second pivot 6b′, and/or lever 8 in position to maintain the desired tension of conveying member 2 while conveying system 1 is being operated.

A transfer station generally indicated at 11 can be provided, wherein holding members 3 receive article 4. Transfer station 11 can include an operating device 13 for adjusting holding member 3 to render holding member 3 capable of receiving articles 4. Preferably, holding members 3 are adjusted before articles 4 are positioned to be received by holding members 3. For example, if holding members include gripping members that open and close to receive and retain articles 4 therebetween, the gripping members can be opened at transfer station 11 before articles 4 are aligned with holding members 3. Once articles 4 are in position to be grasped by holding members 3, the gripping members can contact both sides of articles 4, for example, proximate the sealing seam, thus grasping articles 4. Preferably, operating device 13 ensures that the gripping members are placed on both sides of the sealing seam.

Referring to FIG. 1, operating device 13 can include a cam assembly 14 constructed and arranged to adjust holding member 3 to receive article 4 and subsequently to retain article 4 while transporting article 4. Cam assembly 14 can include a ramp 14a connected to a flange 14b coaxially aligned with first pivot 6a′ of first roller 6a. Preferably, ramp 14a is mounted on lever 8, more preferably fixedly mounted on lever 8, such that the distance between ramp 14a and conveying member 2 is fixed regardless of the displacement of second roller 6b. Flange 14b can also be fixed on lever 8, or alternatively, flange 14b can rotate with first roller 6a or move coincidentally with conveying member 2.

In accordance with an exemplary embodiment, ramp 14a can extend between first and second pivots 6a′, 6b′ and can be constructed and arranged to be contacted by an actuating member 3a of holding member 3 as holding member 3 passes through transfer station 11. More specifically, as actuating member 3a of holding member 3 moves along ramp 14a, holding member 3 can become opened or otherwise ready to receive article 4. As actuating member 3a moves along flange 14b, holding member 3 can be maintained in the opened position or otherwise remain ready to receive article 4. Once actuating member 3a no longer contacts flange 14b, holding member 3 can be returned to the closed position or otherwise in a position to grasp and retain article 4. Referring to FIG. 1, article 4 can be positioned by a running guide 12 beneath first roller 6a to be received by holding member 3.

Running guide 12 can be provided at transfer station 11 to direct articles 4 to holding members 3 to facilitate proper positioning of articles 4 with respect to holding members 3. Referring to the FIG. 1, running guide 12 can be positioned at a predetermined distance from first roller 6a on the opposite side from second roller 6b. For example, running guide 12 can be positioned beneath first roller 6a. Therefore, the positional relationship between conveying member 2 and first roller 6a is preferably not altered by the displacement of second roller 6b.

Conveyor system 1 can also include a plurality of guides for facilitating proper positioning and alignment of conveying member 2. For example, a first guide 5 and a second guide 15 can be provided upstream from transfer station 11 with respect to the conveying direction F. First guide 5 is preferably connected to, preferably formed integrally with, second guide 15, wherein second guide 15 is preferably downstream from first guide 5. Second guide 15 can be positioned proximate second roller 6a and can include a clearance 15a to facilitate the movement of conveying member 2 toward second roller 6a. Referring to the embodiment shown in FIG. 1, clearance 15a can have a funnel shape. Such an arrangement preferably facilitates the movement of conveying member 2 toward second roller 6b regardless of the displacement of second roller 6b along direction S.

Second guide 15 preferably includes a second roller guide 15b constructed and arranged to guide the movement of conveying member 2 as conveying member 2 moves along second roller 6b. Second roller guide 15b can be positioned downstream from clearance 15a and can be coaxial with first pivot 6a′ of first roller 6a. Preferably, conveying member 2 engages second roller 6b on one side and is guided by second roller guide 15b on the opposite side from second roller 6b. Second roller guide 15b is preferably shaped to correspond to the path of conveying member 3, and thus the curvature of second roller 6b.

A third guide 16 can be provided between second roller 6b and first roller 6a to facilitate proper displacement of conveying member 3 toward first roller 6a. Preferably, third guide 16 is connected to lever 8, more preferably fixed with respect to lever 8. Therefore, the distance between third guide 16 and conveying member 2 and lever 8 can remain constant regardless of the displacement of second roller 6b in direction S.

During operation of conveyor system 1 in accordance with an embodiment of the invention, conveying member 2 having holding members 3 is displaced in conveying direction F, preferably driven by a driving roller. Conveying member 2 can move along, preferably through first guide 5 in conveying direction F toward rollers 6. Conveying member 2 can be displaced about, preferably run along, second roller 6b. Conveying member 2 preferably is displaced toward first roller 6a, moving between third guide 16 and lever 8, which facilitate directing conveying member 2 toward first roller 6a. Holding members 3 are preferably brought into an open position or otherwise disposed to receive articles 4, and subsequently disposed to grasp and transport articles 4.

Should the tension of conveying member 2 loosen during the conveying process, for example, if conveying member 2 becomes elongated, rollers 6 wears down, etc., adjustment member 9 can be actuated to adjust the tension of conveying member 2. Adjustment member 9 can displace second roller 6b, for example, by pivotally displacing lever 8 in direction S. Preferably, lever 8 is displaced away from adjustment member 9 and second roller 6b is urged toward conveying member 2. Therefore, the distance traveled by conveying member 2 can be increased, and the desired tension can be achieved and maintained.

Lever 8 is preferably fixed to second roller 6b, ramp 14a and third guide 16, and therefore moves coincidentally therewith. Therefore, the relative position between conveying member 2 and operating device 13, more specifically, cam assembly 14, can remain constant regardless of the displacement of lever 8 and second roller 6b in direction S.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without diverging from the spirit of the invention. For example, whereas the examples of the conveying member has been described herein as including chains and belts, it is to be understood that any conveying member, preferably a continuously rotating conveying member, is contemplated and does not divert from the scope of the invention. Additionally, the holding members, locking mechanism, adjustment device, etc. can be varied as a matter of application specific design choice. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1-10. (canceled)

11. A conveyor system comprising:
a conveying member having a plurality of holding members, the holding members being constructed and arranged to grasp an article, the conveying member having a first tension and a second tension;
a first roller; and
a second roller displaceable with respect to the first roller;
wherein the conveying member is displaced about the first roller and the second roller; and
wherein displacing the first roller adjusts the tension of the conveying member between the first tension and the second tension.

12. The conveyor system of claim 11, further comprising a transfer station at which one of the articles is grasped by one of the holding members.

13. The conveyor system of claim 11, further comprising a lever constructed and arranged to displace the second roller with respect to the first roller.

14. The conveyor system of claim 13, further comprising a locking mechanism constructed and arranged to maintain the lever in a locked position.

15. The conveyor system of claim 13, further comprising a cam mechanism constructed and arranged such that the holding member contacts the cam mechanism and is opened as the holding member is displaced along the cam mechanism.

16. The conveyor system of claim 11, wherein the conveying member is displaced by the first and second rollers.

17. A conveyor system comprising:
a conveying member;
a fixed roller;
a displaceable roller;
a plurality of holding members each constructed and arranged to retain an article being conveyed;
the conveying member having a tension and being constructed and arranged to continuously rotate about the first and second rollers;
a transfer station at which the articles are transferred to the holding members, the transfer station operatively connected to the fixed roller; and
a tensioning assembly comprising the displaceable roller, the tensioning assembly being displaceable to adjust the tension of the conveying member.

18. The conveyor system of claim 17, further comprising a tension lever connecting the displaceable roller and the fixed roller, wherein the fixed roller is selectively rotatable about a pivot, and wherein the tension lever is pivotable about the pivot.

19. The conveyor system of claim 17, wherein the transfer station further comprises an operating assembly constructed and arranged to open or close the holding member.

20. The conveyor system of claim 17, wherein the fixed roller comprises a pivot, and wherein the transfer station further comprises an operating assembly constructed and arranged to open or close the holding member as the operating assembly pivots about the pivot.

21. The conveyor system of claim 20, wherein the operating assembly comprises a cam.

22. The conveyor system of claim 20, wherein the operating assembly comprises a cam, and wherein the holding members open and close as the holding members are displaced along the cam.

23. The conveyor system of claim 20, wherein the operating assembly comprises a ramp rotatable about the pivot.

24. The conveyor system of claim 20, further comprising a tension lever connecting the displaceable roller and the fixed roller, wherein the tension lever comprises the operating assembly.

25. The conveyor system of claim 17, further comprising a conveyor guide constructed and arranged to position the conveying member with respect to the tension lever.

26. The conveyor system of claim 17, further comprising a guide constructed and arranged to position the conveying member with respect to the displaceable roller.

27. The conveyor system of claim 18, further comprising a locking assembly constructed and arranged to retain the tension lever in a tensioning position.

28. The conveyor system of claim 17, wherein the conveying member comprises a chain, the holding members comprise one or more grippers, and wherein the grippers are positioned at predetermined distances along the chain.

29. The conveyor system of claim 17, wherein the conveying member is rotatable about the fixed roller and the displaceable roller.

30. A conveyor system comprising:
a conveying member having a plurality of holding members,
the holding members having a first position and a second position, the holding member being constructed and arranged to grasp an article at the first position, the conveying member having a first tension and a second tension;
a roller having a pivot about which the roller rotates;
a lever displaceable about the pivot of the first roller;
wherein the conveying member is displaced about the first roller and the second roller;
wherein displacing the lever adjusts the tension of the conveying member between the first tension and the second tension; and
a transfer assembly constructed and arranged to adjust the holding members between the first position and the second position.
